(19) United States
(12) Patent Application Publication
(10) Pub. No.: US 2021/0140194 A1
(43) Pub. Date: May 13, 2021

(54) FENCING SYSTEM WITH ENGINEERED WOOD FENCE PICKETS AND METAL SUPPORTS

(71) Applicant: LOUISIANA-PACIFIC CORPORATION, NASHVILLE, TN (US)

(72) Inventors: JARROD KEVIN LINE, BRENTWOOD, TN (US); JESSE SCHMITZ, NASHVILLE, TN (US)

(21) Appl. No.: 17/142,386

(22) Filed: Jan. 6, 2021

Related U.S. Application Data
(63) Continuation of application No. 17/095,597, filed on Nov. 11, 2020.
(60) Provisional application No. 62/933,574, filed on Nov. 11, 2019.

(51) Int. Cl. E04H 17/14

(52) U.S. Cl. CPC E04H 17/14; E04H 17/1447

(57) ABSTRACT

A fence or fencing system with engineered-wood fence pickets installed or mounted on metallic rails by special wood-to-metal pins or fasteners. The wood-to-metal pins or fasteners are driven linearly through the pickets and the rails to secure the pickets to the rails. The engineered wood pickets may be treated. The fence rails may be made of any suitable metallic material, such as, but not limited to, steel, aluminum, or similar metals. The rails generally extend horizontally between posts which are installed into the ground. The posts may be made of any suitable material, including, but not limited to, steel, aluminum, similar metals, wood, composites, or combinations thereof.

This application is a continuation of U.S. patent application Ser. No. 17/095,597, filed Nov. 11, 2020, which claims priority to and benefit of U.S. Provisional App. No. 62/933,574, filed Nov. 11, 2019, both of which are incorporated herein in their entireties by specific reference for all purposes.

### FIELD OF INVENTION

This invention relates to a method and system for manufacturing and constructing fencing comprising engineered wood fence pickets or panels installed on metallic posts and rails.

### SUMMARY OF INVENTION

In various exemplary embodiments, the present invention comprises a system comprising a fence picket (or other fencing component) made from engineered wood products, including, but not limited to, oriented-strand board (OSB), fiberboard, laminated strand lumber (LSL), plywood or laminated veneer lumber (LVL) installed or mounted on metallic rails and/or posts. The engineered wood products may be treated. Engineered wood products provide the authentic look and appeal of real wood, but with the advantages of engineered wood.

The system comprises fence rails made of a metallic material, such as, but not limited to, steel, aluminum, or similar metals. The rails may be rectilinear in cross-section (although other shapes may be used), and extend horizontally between posts which are installed into the ground by means known in the prior art (e.g., post holes are dug and the posts cemented or otherwise secured therein). The posts may be made of any suitable material, including, but not limited to, steel, aluminum, similar metals, wood, composites, or combinations thereof. Rails may be attached or mounted to the posts by conventional means known in the prior art, or by special metal-to-metal or metal-to-wood pins.

The engineered-wood fence pickets are fastened or affixed to the metal rails by means of a wood-to-metal pin or fastener. This eliminates the need to use screws (e.g., self-tapping screws) as fasteners, thereby allowing current installation practices to be maintained (i.e., the pin is driven through the fence picket into the rails during installation). Standard wood nails cannot be used, as they will not adequately penetrate the metal rail in such a way as to securely hold the fence picket thereto. A pneumatic gun, similar device, may be used to drive the pin/fastener during installation. This attachment method eliminates a significant barrier to entry for combined wood/metal fencing (i.e., the use of screws substantially increases installation time and costs). The present invention reduces the installation time for a single picket to a plurality of rails by an order of magnitude.

The metal rails and/or posts may be finished in a variety of ways, and may be finished to match or coordinate with the appearance of the fence pickets. The combination of the long service life of the engineered wood fence pickets with the long-life, durable metallic support system (rails and/or posts) makes the resulting fence competitive with current composite and vinyl fence systems in terms of both durability (service-life) and price.

### BRIEF DESCRIPTION OF THE DRAWINGS

FIG. 1 shows a view of a fence section engineered wood fence pickets or panels installed on metallic posts and rails.

FIG. 2 shows a side view of the fence section of FIG. 1.

FIG. 3 shows an example of a wood-to-metal pin.

FIG. 4 shows an example of metal-to-metal pin.

FIG. 5 shows a cross-section of a rail.

FIG. 6 shows a cross-section of an alternative embodiment of a rail.

FIG. 7 shows a cross-section of yet another alternative embodiment of a rail.

### DETAILED DESCRIPTION OF EXEMPLARY EMBODIMENTS

In several exemplary embodiments, the present invention comprises a system comprising a fence picket (or other fencing component) made from engineered wood products, including, but not limited to, oriented-strand board (OSB), fiberboard, laminated strand lumber (LSL), plywood or laminated veneer lumber (LVL) installed or mounted on metallic rails and/or posts. The engineered wood products may be treated. Engineered wood products provide the authentic look and appeal of real wood, but with the advantages of engineered wood. Manufacturing of such fence pickets and components is disclosed is U.S. patent application Ser. No. 16/189,995, filed Nov. 13, 2018, which is incorporated herein in its entirety by specific reference for all purposes.

As seen in the accompanying figures, the system comprises rails 20 made of a metallic material, such as, but not limited to, steel, aluminum, or similar metals. In the embodiment shown, the rails are rectilinear in cross-section (although other shapes may be used), and extend horizontally between posts 10 which are installed into the ground by means known in the prior art (e.g., post holes are dug and the posts cemented or otherwise secured therein). Metal rails typically have a hollow interior, thereby reducing the weight of the rail with the thickness of the wall providing strength, although in some embodiments a metal rail may be solid, or have a non-metallic core. The posts 10 may be made of any suitable material, including, but not limited to, steel, aluminum, similar metals, wood, composites, or combinations thereof.

The metal rails can take a variety of shapes or configurations. In one embodiment, the rail is a hollow rectilinear tube, rectilinear in cross section, as seen in FIG. 5. In an alternative embodiment, the rail is a squared-off C in cross section, as seen in FIG. 6. In a further alternative embodiment, the rail has an orthogonal Z-shape in cross section, as seen in FIG. 7. In general, the metal rail has a face configured to be penetrated by a wood-to-metal pin or fastener 40 and thereby securely hold a fence picket or other fence component.

The engineered-wood fence pickets 30 are fastened or affixed to the metal rails 20 by means of a wood-to-metal pin or fastener 40. This eliminates the need to use prior-art screws (e.g., self-tapping screws) as fasteners. In the present system, the pin 40 is driven through the fence picket into the rails during installation. In contrast to a self-tapping screw, in several embodiments the pin may be driven linearly, without substantial rotation. That is, a screw must be rotated around its longitudinal axis, with the threads of the screw biting into the penetrated material. Standard wood or other nails cannot be used, as they will not adequately penetrate the metal rail in such a way as to securely hold the fence picket thereto. Further, no holes need to be pre-drilled into picket or rail to receive the pins or fasteners 40.

As seen in FIGS. 2 and 3, the pin or fastener 40 penetrates the wood-based picket and punctures the metal rail in such a manner as to secure the picket to the rail. This pin-based attachment method eliminates a significant barrier to entry for combined wood/metal fencing (i.e., the use of screws substantially increases installation time and costs).

In several embodiment, the pin or fastener 40 comprises an elongated body or shank having a first end and second end. The first end comprises a pointed tip, which may be conically shaped, to enable the pin to puncture and penetrate through the picket material and rail material when a linear force is applied to the pin (i.e., when the pin is driven into the picket material and rail material) A head portion is generally formed at the second end. As shown, the head portion may be flat or substantially flat, although in a variety of embodiments, different head shapes and geometry may be used, such as, but not limited to, flanged, countersunk, or recessed head configurations.

Some or all of the body or shank of the pin may be knurled or grooved 60. The grooves or knurling may be circumferential or spiral, and may extend substantially along a section of the shank between the first and second end. The grooves or knurling, if present, help secure the pin to the materials penetrated. If spiral, the grooves or knurling may impart some minor rotation to the body or shank. However, rotational force is not applied to the fastener through the head (such as would be applied through by a screwdriver or similar tool).

The pin or fastener 40 may be of various lengths or diameters, formed to fit a variety of different configurations and materials, such as thicknesses or types of the engineered wood pickets or the metallic rails. Pins or fasteners are generally made from a materials such as steel or similar hard, durable metal. They may be heat-treated or tempered to increase its strength, both for penetration and securing the pickets to the rails. In some embodiments, a composite or synthetic material may be used, provided the material has sufficient strength and durability to penetrate and hold the materials forming the pickets and rails described above.

In various embodiments, a pin may range from approximately 0.75 inches to approximately 4 inches in length, and approximately 0.1 inches to approximately 0.3 inches in diameter. The tip typically will have an angle or point of from about 6 degrees to 20 degrees or more, depending on the material being penetrated. The pin may be coated or treated (e.g., zinc electroplating or similar coatings), which generally provide increased or improved wear and/or corrosion resistance.

A pneumatic gun, detonation-operated driving or nailing tool, or similar device may be used to drive the pins/fasteners 40, 50 during installation for faster and more efficient construction, and to create an effective contact or weld with the metal materials. Other tools and devices, as known in the prior art, may also be used to drive the pins/fasteners.

The present invention reduces the installation time for a single picket to a plurality of rails by an order of magnitude. For example, the installation of a single fence picket with six self-tapping screws (two for the top rail, two for the middle rail, and two for the bottom), typically take an average of 60 to 100 seconds even with use of a power drill. With the present invention, the installation of that same single fence picket with six wood-to-metal pins using a pneumatic pin gun (similar in function to a nail gun) takes an average of 10 seconds. The savings in time and labor costs for the installation of an entire section of fencing thus is greatly reduced.

The metal rails and/or posts may be finished in a variety of ways, and may be finished to match or coordinate with the appearance of the fence pickets. The combination of the long service life of the engineered wood fence pickets with the long-life, durable metallic support system (rails and/or posts) makes the resulting fence competitive with current composite and vinyl fence systems in terms of both durability (service-life) and price.

Rails 20 may be attached or mounted to the posts 10 by conventional means known in the prior art, such as self-tapping screws. In several embodiments, however, an appropriate metal-to-metal or wood-to-metal pin or fastener may be used. FIG. 4 shows an example of metal-to-metal pin 50 that may be used to fasten a metal rail to a metal post. The metal-to-metal pin 50 may be substantially similar in design to the wood-to-metal pin 40. Similarly, the pin 40 of FIG. 3 may be used to fasten a metal rail to a wood or wood-based post.

Additional examples of fasteners are disclosed in Shluzas, et al., U.S. Pub. No. 2008/0247843 (application. Ser. No. 12/052,779); Greene, et al., U.S. Pub. No. 2007/0217889 (application. Ser. No. 11/420,450); and Oswald, U.S. Pat. No. 6,805,525 (application. Ser. No. 09/734,301); all of which are incorporated herein in their entireties by specific reference for all purposes.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A fence, comprising:
a plurality of fence posts, configured to be installed on a surface or in the ground;
a plurality of metal fence rails, each fence rail comprising a first end and a second end and affixed to at least one of said plurality of fence posts; and
a plurality of engineered-wood fence pickets, each fence picket affixed to two or more of said plurality of metal fence rails by a plurality of wood-to-metal pins.

2. The fence of claim 1, wherein the wood-to-metal pins each comprise a shank with a head end and a penetration end.

3. The fence of claim 2, wherein the head end is substantially flat and smooth.

4. The fence of claim 2, wherein the wood-to-metal pins are configured to be linearly driven through the corresponding engineered-wood fence picket and metal rail.

5. The fence of claim 2, wherein the wood-to-metal pins are configured to be linearly driven without rotation through the corresponding engineered-wood fence picket and metal rail.

6. The fence of claim 1, further wherein each metal fence rail is affixed to said at least one of said plurality of fence posts by one or more metal-to-metal pins.

7. The fence of claim 1, further wherein each metal fence rail is affixed to said at least one of said plurality of fence posts by one or more metal-to-wood pins.

8. The fence of claim 1, wherein the plurality of fence posts comprise metal fence posts.

9. A metal-and-wood fencing system, comprising:
at least one fencing section, said fencing section comprising two fence posts, each fence posts installed in the ground and extending vertically;
a top metal fence rail with a first end and a second end, each end affixed to a corresponding fence post;
a bottom metal fence rail with a first end and a second end, each end affixed to a corresponding fence post at a position below the top metal fence rail; and
one or more fence pickets with an upper end and a lower end, said fence pickets comprising engineered-wood and extending vertically substantially parallel to the two fence posts;
wherein the one or more fence pickets are affixed to the top metal fence rail proximate to the corresponding upper end, and affixed to the bottom metal fence rail proximate to the corresponding lower end, by one or more wood-to-metal pins.

10. The system of claim 9, wherein the wood-to-metal pins each comprise a shank with a head end and a penetration end.

11. The system of claim 10, wherein the head end is substantially flat and smooth.

12. The system of claim 10, wherein the wood-to-metal pins are configured to be linearly driven through the corresponding engineered-wood fence picket and metal rail.

13. The system of claim 10, wherein the wood-to-metal pins are configured to be linearly driven without rotation through the corresponding engineered-wood fence picket and metal rail.

14. The system of claim 9, further comprising a middle metal fence rail with a first end and a second end, each end affixed to a corresponding fence post at a position below the top metal fence rail and above the bottom metal fence rail.

15. A method of constructing a section of wood-and-metal fencing, comprising the steps of:
installing at least two fence posts on a surface or in the ground;
affixing a first metal fence rail to the at least two fence posts and extending therebetween;
affixing a second metal fence rail to the at least two fence posts and extending therebetween;
affixing at least one engineered-wood fence picket to the first metal fence rail and the second metal fence rail and extending therebetween,
wherein the at least one fence picket is affixed to the metal fence rails by one or more wood-to-metal pins.

16. The method of claim 15, wherein the wood-to-metal pins each comprise a shank with a head end and a penetration end.

17. The system of claim 16, wherein the head end is substantially flat and smooth.

18. The system of claim 16, wherein the wood-to-metal pins are configured to be linearly driven through the corresponding engineered-wood fence picket and metal rail.

19. The system of claim 16, wherein the wood-to-metal pins are configured to be linearly driven without rotation through the corresponding engineered-wood fence picket and metal rail.

20. The system of claim 19, wherein the wood-to-metal pins are linearly driven by a pneumatic or air-driven gun.
